(19) United States
(12) Patent Application Publication
(10) Pub. No.: US 2011/0320321 A1
(43) Pub. Date: Dec. 29, 2011

(54) Establishing and Utilizing Custom Prices Between a Customer and a Manufacturer

(76) Inventor: R. Roland Rodriguez, San Antonio, TX (US)

(21) Appl. No.: 12/826,381

(22) Filed: Jun. 29, 2010

(51) Int. Cl. G06Q 30/00; G06F 17/00

(52) U.S. Cl. 705/27.1; 705/400

(57) ABSTRACT

Establishing and utilizing custom prices between a customer and a manufacturer. A plurality of product catalogs may be stored. Information regarding special pricing agreements for a plurality of customers may be established and stored. The special pricing agreement information may specify special pricing for certain products. Customer identification information may be received from a first customer device identifying a first customer. Correspondingly, the first customer may be identified. First catalog information may be provided for display to the first customer. The first catalog information may be generated based on at least one of the plurality of product catalogs stored in computer memory and special pricing agreement information for the first customer. Thus, the first catalog information may include special pricing for the first customer, e.g., for a first product. Accordingly, input may be received and stored which specifies purchase of a quantity of the first product at the special price.

### FIELD OF THE INVENTION

The present invention relates to the field of distribution, and more particularly to a system and method for establishing and utilizing custom prices between a customer and a manufacturer.

### DESCRIPTION OF THE RELATED ART

Present distribution channels from manufacturers to customers are convoluted and often hard to manage. For example, while customers may have access to particular printed or static catalogs of distributors or manufacturers, they must call the distributor in order to establish custom pricing agreements with the manufacturer. In turn, the distributor must also contact the manufacturer in order to determine the custom pricing agreements for the customer. Additionally, these custom pricing agreements are usually established by using rebates from the distributor or manufacturer, which is hard to record and maintain, and involves initial overpayments by the customer. Accordingly, improvements in establishing and utilizing custom prices for product purchases by customers are desired.

### SUMMARY OF THE INVENTION

Various embodiments are presented of a system and method for establishing and utilizing custom prices between a customer and manufacturer.

Initially, special pricing agreement may be reached for a customer. More specifically, customer identification information may be received over a wide area network (e.g., the Internet) from a customer device (e.g., a computer or portable device, such as a cell phone). The customer identification may identify a particular customer, or a particular customer's device. The customer identification information may be provided in various forms. For example, if it is a new customer, the customer may provide identification information over the wide area network. Alternatively, previously stored identification information may be provided which identifies the customer. For example, a digital certificate may be received from the first customer device, which may be specific to the customer or the customer's device.

Catalog information may be provided for display to the customer over the wide area network. For example, the catalog information may be provided to the customer device for display to the customer. The catalog information may specify prices for a plurality of different products. More specifically, the catalog information may at least specify a price (e.g., a stock price) for a first product.

Customer input specifying a quote request may be received. The quote request may specify a product purchase, which may include one or more products and quantities of the one or more products. In particular, the product purchase may specify the first product and a quantity of the first product. In some embodiments, the product purchase may be specified via a number of different ways. For example, the customer may select various parts from the catalog information above, e.g., the customer may select them from a graphical user interface which is usable to select parts and quantities. In further embodiments, the customer may also be able to specify a product via a product description, e.g., by describing the desired product. When specifying the product in this manner, the customer may not specify that product via the selection of stock products from the catalog information. The customer input (e.g., the quote request) may include a “need by” date and, optionally, a time for the product purchase. The customer input may further specify a shipping destination, a description of the job that the products are being used for, etc. By providing the quote request, the customer may wish to receive a negotiated or special price for the first product, e.g., because the customer is purchasing the first product in bulk.

The quote request may be provided to a distributor (e.g., a computer of the distributor) over the wide area network. In some embodiments, the distributor may specify contact information for a manufacturer. For example, the distributor may select a specific agent or representative of the manufacturer based on an established relationship and/or based on the specific product purchase. The contact information may include the contact's name, phone number, email address, user name, and/or other contact information. Where the customer has specified a product for purchase via a description, the distributor may specify the manufacturer's product (e.g., the product code) corresponding to the provided description.

The product purchase may be provided to the manufacturer over the wide area network. Where the distributor has selected specific contact information of the manufacturer, the provision may be performed using that contact information. For example, the product purchase may be provided to a specific manufacturer agent or representative as specified in the contact information.

Special pricing proposal information may be received from the manufacturer computer over the wide area network. The special pricing proposal may include pricing for the product purchase which is different from the prices listed in the catalog information. More specifically, the special pricing proposal may specify a price for the first product which is different than the catalog's listed price for the first product, e.g., based on the quantity specified in the product purchase.

The special pricing proposal information may be provided to the distributor computer over the wide area network. The distributor may modify the special pricing proposal to form a quote for the customer, e.g., adding a distributor's mark up to the special pricing proposal.

Correspondingly, the quote for the product purchase may be received from the distributor computer over the wide area network. The quote for the product purchase from the distributor computer may be based on the special pricing proposal information from the manufacturer computer. Similar to the special pricing proposal, the quote may include a special pricing agreement for the product purchase for the first customer. Thus, the special pricing agreement price for the first product may be less than the price for the first product as listed in the catalog information.

The quote may be provided to the first customer computer over the wide area network. In embodiments where the quote includes a product purchase including a plurality of products (e.g., the first product and a second product), the quote may comprise unit pricing (prices per product) or lot pricing (price for the entire purchase). The specification of unit pricing or lot pricing may be based on the customer (e.g., if the customer tends to shop around for more better prices on each unit), input from the distributor, and/or input from the manufacturer (e.g., if the distributor or manufacturer does not want to be price shopped), among other possibilities.

The special pricing agreement for the product purchase may be stored in response to said receiving the quote. The special pricing agreement may be associated with the first customer identification information and may be useable to establish pricing for the first product for the first customer.

At a later time, the customer may wish to purchase more items using his special pricing agreements. Thus, information regarding special pricing agreements may be stored for a plurality of customers. For each respective customer, the special pricing agreement information comprises information on special pricing for certain products previously negotiated by the respective customer with a respective distributor and/or manufacturer, e.g., according to the process above.

Similar to above, customer identification information may be received over the wide area network from the customer device which identifies the customer. Correspondingly, the customer may be identified based on the customer identification information.

Catalog information may be provided over the wide area network for display to the customer by the customer device. The catalog information may be generated based on at least one of a plurality of product catalogs stored in computer memory and special pricing agreement information for the customer. The special pricing agreements may have associated expiration dates. Accordingly, the method may determine whether the special pricing agreements are still valid, and if they are, include them in the catalog information. Otherwise, the expired special pricing agreements may not be provided in the catalog information.

In some embodiments, the catalog information may be specific to a particular distributor and a particular manufacturer, e.g., the catalog may be a “cobrand” catalog. In some embodiments, the catalog information may only include a restricted portion of the particular manufacturer's products based on the distributor (e.g., the distributor may only sell a portion of the manufacturer's products). Thus, the provided catalog information may include special pricing for the customer, e.g., for the products negotiated above.

Further, the catalog information may include a list of one or more favorite products, e.g., that are specific to the customer (i.e., they are the customer's favorite products).

Correspondingly, customer input, which specifies purchase of a quantity of one of these negotiated products, may be received over the wide area network and stored. The customer input may specify purchase of the quantity of the first product at the special pricing. Thus, the customer may purchase one or more products using previously negotiated prices that are specific to the customer. In some embodiments, the customer may select one or more products from the list of favorite products, described above.

Additionally, the first customer input specifying the purchase may be specified de novo, e.g., by selecting products from the catalog information, or may be based on previous orders. For example, the method may include providing a previous order to the customer (e.g., based on customer input) and receiving user input modifying or accepting purchase of that previous order.

### BRIEF DESCRIPTION OF THE DRAWINGS

A better understanding of the present invention can be obtained when the following detailed description of the preferred embodiment is considered in conjunction with the following drawings, in which:

FIG. 1 illustrates exemplary computer systems coupled via a network 150, according to some embodiments;

FIG. 2 is a flowchart of one embodiment of a method for establishing special pricing agreements for a customer;

FIG. 3 is a flowchart of one embodiment of a method for establishing special pricing agreements for a customer; and

FIGS. 4-20 are exemplary screenshots corresponding to the described methods; according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Portable Device—any of various types of computer systems which are mobile or portable, including laptops, netbooks, tablet computers, PDAs, mobile or cellular telephones, handheld devices, portable Internet devices, music players, data storage devices, etc. In general, the term “portable device” can be broadly defined to encompass any electronic, computing, and/or telecommunications device (or combination of devices) which is easily transported by a user.

Manufacturer—a company or entity which produces products to be purchased. The term “manufacturer” may broadly encompass the company or any agent that represents the manufacturer. The term “manufacturer” includes its ordinary accepted meaning in the art.

Distributor—a company or entity which acts as an intermediary between a manufacturer and a customer. The term “distributor” may broadly encompass the company or any agent that represents the distributor. The term “distributor” includes its ordinary accepted meaning in the art.

Customer—a person or entity which purchases goods, usually from a distributor. The term “customer” includes its ordinary accepted meaning in the art.

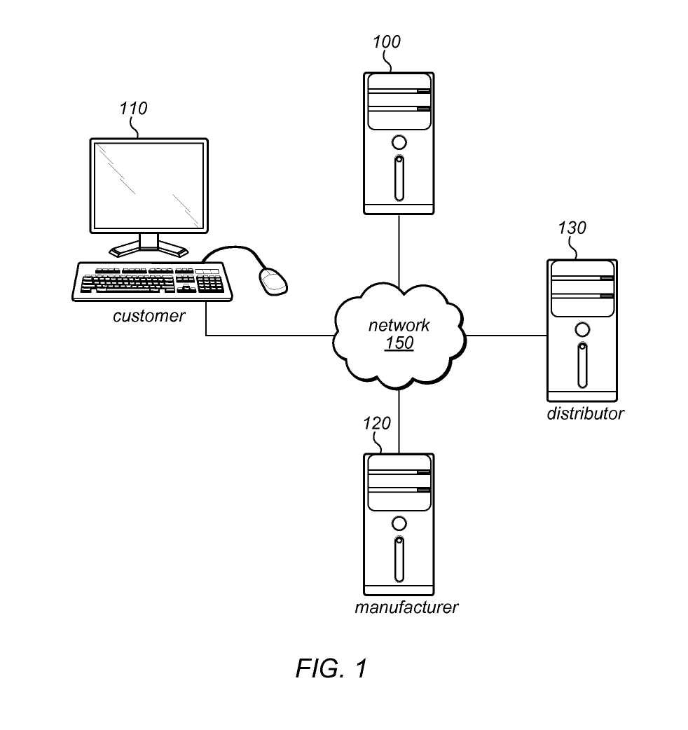

### FIG. 1—Computer Network

As shown in FIG. 1, computer system 100 (e.g., one or more servers) may be coupled with customer device 110 (shown as a computer system, but which could be a different device, such as a portable device), manufacturer computer system 120, and distributor computer system 130 over network 150. The network 150 can also be any of various types, including a LAN (local area network), WAN (wide area network, such as the Internet), or an Intranet, among others.

The computer systems 100, 110, 120, and 130 may be any of various computer systems (including one or more computer devices) and include one or more processors and memory mediums. Various computer programs or software components may be stored on the memory mediums for execution by the processors. The memory mediums may store operating system software, as well as other software for operation of the computer system.

The computer system 100 may include a plurality of web servers which may operate one or more web sites for performing the methods described herein. Additionally, the computer system 100 may store and/or manage one or more databases, e.g., which store catalog information for one or more catalogs, user information, special pricing agreements, etc. In some embodiments, there may be a web site for each catalog (e.g., with a corresponding database) and/or a website for all of the catalogs. Additionally, there may be a website specialized for customers, another for distributors, and another for manufacturers, or each entity may be able to access the same website, as desired. Thus, the computer system 100 may take on any of a variety of configurations in order to provide the methods described herein.

The memory mediums may store program instructions which are executable to implement various embodiments described herein. For example, the computer systems 110, 120, and/or 130 may execute a browser program which may communicate with web servers executed by computer system 100, e.g., via web pages. Alternatively, the computer systems 110, 120, and/or 130 may execute stand alone programs to implement various embodiments of the invention. In further embodiments, any combination of the distributed processing (e.g., via web pages) or stand alone programs may be used among any of the computer systems 110, 120, and/or 130 (e.g., in communication with computer system 100 over the network 150). In embodiments described below, these computer systems may be involved in establishing special pricing agreements between customers and distributors or manufacturers.

The various computer systems may include one or more display devices configured to display a graphical user interface for establishing and using special pricing agreements, as described below. The graphical user interface may comprise any type of graphical user interface, e.g., depending on the computing platform.

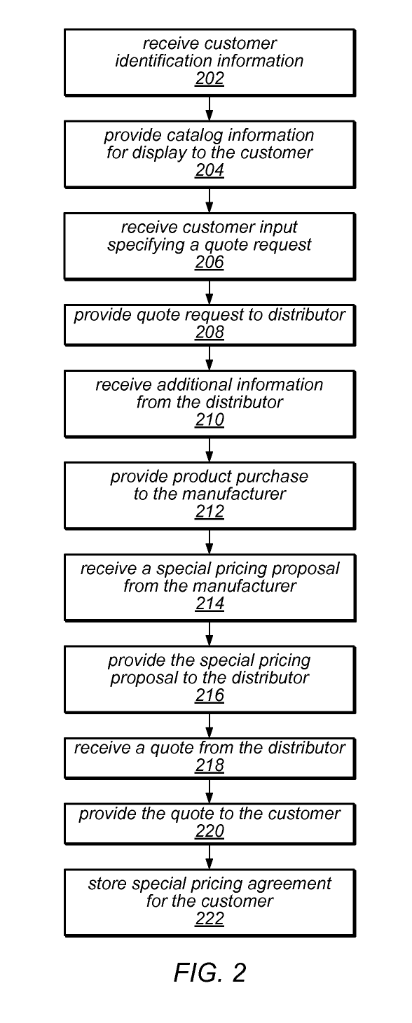

### FIG. 2—Establishing Special Pricing Agreements for a Customer

FIG. 2 illustrates a method for establishing special pricing agreements for a customer. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 202, customer identification information may be received over a wide area network (e.g., the Internet) from a customer device (e.g., a computer or portable device, such as a cell phone). The customer identification may identify a particular customer, or a particular customer's device. The customer identification information may be provided in various forms. For example, if it is a new customer, the customer may provide identification information over the wide area network, e.g., including the customer's name, address, billing information, shipping information, phone number, and/or other information. Alternatively, previously stored identification information may be provided which identifies the customer. For example, a digital certificate may be received from the first customer device, which may be specific to the customer or the customer's device. This digital certificate may be associated with identification information of the customer (e.g., stored in a database). Alternatively, or additionally, the user may simply login, using login credentials (such as a user name and password, although other information may also be provided or required).

In 204, catalog information may be provided for display to the customer over the wide area network. For example, the catalog information may be provided to the customer device for display to the customer. The catalog information may specify prices for a plurality of different products. More specifically, the catalog information may at least specify a price (e.g., a stock price) for a first product.

In 206, customer input specifying a quote request may be received. The quote request may specify a product purchase, which may include one or more products and quantities of the one or more products. In particular, the product purchase may specify the first product and a quantity of the first product. In some embodiments, the product purchase may be specified via a number of different ways. For example, the customer may select various parts from the catalog information above, e.g., the customer may select them from a graphical user interface which is usable to select parts and quantities. In further embodiments, the customer may also be able to specify a product via a product description, e.g., by describing the desired product. When specifying the product in this manner, the customer may not specify that product via the selection of stock products from the catalog information (or even via product numbers).

The customer input (e.g., the quote request) may include a “need by” date and, optionally, a time for the product purchase. The customer input may further specify a shipping destination, a description of the job that the products are being used for, etc. By providing the quote request, the customer may wish to receive a negotiated or special price for the first product, e.g., because the customer is purchasing the first product in bulk.

In 208, the quote request may be provided to a distributor (e.g., a computer of the distributor) over the wide area network. Note that the quote request may be provided to a specific location or store of the distributor or may be provided to an overarching distributor system. For example, the quote request may be provided from a customer in Austin, Tex. to a particular distributor store in Austin, Tex. or may simply be provided to the distributor, as desired.

In some embodiments, the distributor may specify contact information for a manufacturer. For example, the distributor may select a specific agent or representative of the manufacturer based on an established relationship and/or based on the specific product purchase. The contact information may include the contact's name, phone number, email address, user name, and/or other contact information. Where the customer has specified a product for purchase via a description, the distributor may specify the manufacturer's product (e.g., the product code) corresponding to the provided description.

Accordingly, in 210, additional information from the distributor may be received (e.g., the contact information, the additional product information, etc.). Note that 208 and 210 may in some embodiments be optional or may be skipped, e.g., where the manufacturer contact information is already known and additional information is not required for products (e.g., or may be provided by the manufacturer instead).

In 212, the product purchase may be provided to the manufacturer over the wide area network. Where the distributor has selected specific contact information of the manufacturer, the provision may be performed using that contact information. For example, the product purchase may be provided to a specific manufacturer agent or representative as specified in the contact information.

In 214, special pricing proposal information may be received from the manufacturer computer over the wide area network. The special pricing proposal may include pricing for the product purchase which is different from the prices listed in the catalog information. More specifically, the special pricing proposal may specify a price for the first product which is different than the catalog's listed price for the first product, e.g., based on the quantity specified in the product purchase.

In 216, the special pricing proposal information may be provided to the distributor computer over the wide area network. The distributor may modify the special pricing proposal to form a quote for the customer, e.g., adding a distributor's mark up to the special pricing proposal.

Correspondingly, in 218, the quote for the product purchase may be received from the distributor computer over the wide area network. The quote for the product purchase from the distributor computer may be based on the special pricing proposal information from the manufacturer computer. Similar to the special pricing proposal, the quote may include a special pricing agreement for the product purchase for the first customer. Thus, the special pricing agreement price for the first product may be less than the price for the first product as listed in the catalog information.

In 220, the quote may be provided to the first customer computer over the wide area network. In embodiments where the quote includes a product purchase including a plurality of products (e.g., the first product and a second product), the quote may comprise unit pricing (prices per product) or lot pricing (price for the entire purchase). The specification of unit pricing or lot pricing may be based on the customer (e.g., if the customer tends to shop around for more better prices on each unit), input from the distributor, and/or input from the manufacturer (e.g., if the distributor or manufacturer does not want to be price shopped), among other possibilities.

In 222, the special pricing agreement for the product purchase may be stored in response to said receiving the quote. The special pricing agreement may be associated with the first customer identification information and may be useable to establish pricing for the first product for the first customer.

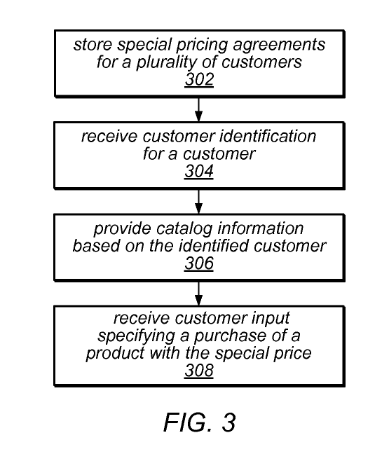

### FIG. 3—Establishing Special Pricing Agreements for a Customer

FIG. 3 illustrates a method for utilizing special pricing agreements of a customer. The method shown in FIG. 3 may be used in conjunction with any of the computer systems or devices shown in the above Figures, among other devices. For example, the method of FIG. 3 may be performed by the same customer at a later time, after establishing the special pricing agreements in FIG. 2. In various embodiments, some of the method elements shown may be performed concurrently, in a different order than shown, or may be omitted. Additional method elements may also be performed as desired. As shown, this method may operate as follows.

In 302, information regarding special pricing agreements may be stored for a plurality of customers. For each respective customer, the special pricing agreement information comprises information on special pricing for certain products previously negotiated by the respective customer with a respective distributor and/or manufacturer, e.g., according to the process above.

In 304, similar to above, customer identification information may be received over the wide area network from the customer device which identifies the customer. Correspondingly, the customer may be identified based on the customer identification information.

In 306, catalog information may be provided over the wide area network for display to the customer by the customer device. The catalog information may be generated based on at least one of a plurality of product catalogs stored in computer memory and special pricing agreement information for the customer. The special pricing agreements may have associated expiration dates. Accordingly, the method may determine whether the special pricing agreements are still valid, and if they are, include them in the catalog information. Otherwise, the expired special pricing agreements may not be provided in the catalog information.

In some embodiments, the catalog information may be specific to a particular distributor and a particular manufacturer, e.g., the catalog may be a “cobrand” catalog. In some embodiments, the catalog information may only include a restricted portion of the particular manufacturer's products based on the distributor (e.g., the distributor may only sell a portion of the manufacturer's products). Alternatively, or additionally, the prices of the manufacturer's products may be based on the particular distributor, e.g., a distributor with a high volume of sales or good relationship may have better prices for a manufacturer than other distributors. As indicated above, the provided catalog information may include special pricing for the customer, e.g., for the products negotiated above.

Further, the catalog information may include a list of one or more favorite products, e.g., that are specific to the customer (i.e., they are the customer's favorite products).

Correspondingly, in 308, customer input, which specifies purchase of a quantity of one of these negotiated products, may be received over the wide area network and stored. The customer input may specify purchase of the quantity of the first product at the special pricing. Thus, the customer may purchase one or more products using previously negotiated prices that are specific to the customer. In some embodiments, the customer may select one or more products from the list of favorite products, described above.

Additionally, the first customer input specifying the purchase may be specified de novo, e.g., by selecting products from the catalog information, or may be based on previous orders. For example, the method may include providing a previous order to the customer (e.g., based on customer input) and receiving user input modifying or accepting purchase of that previous order.

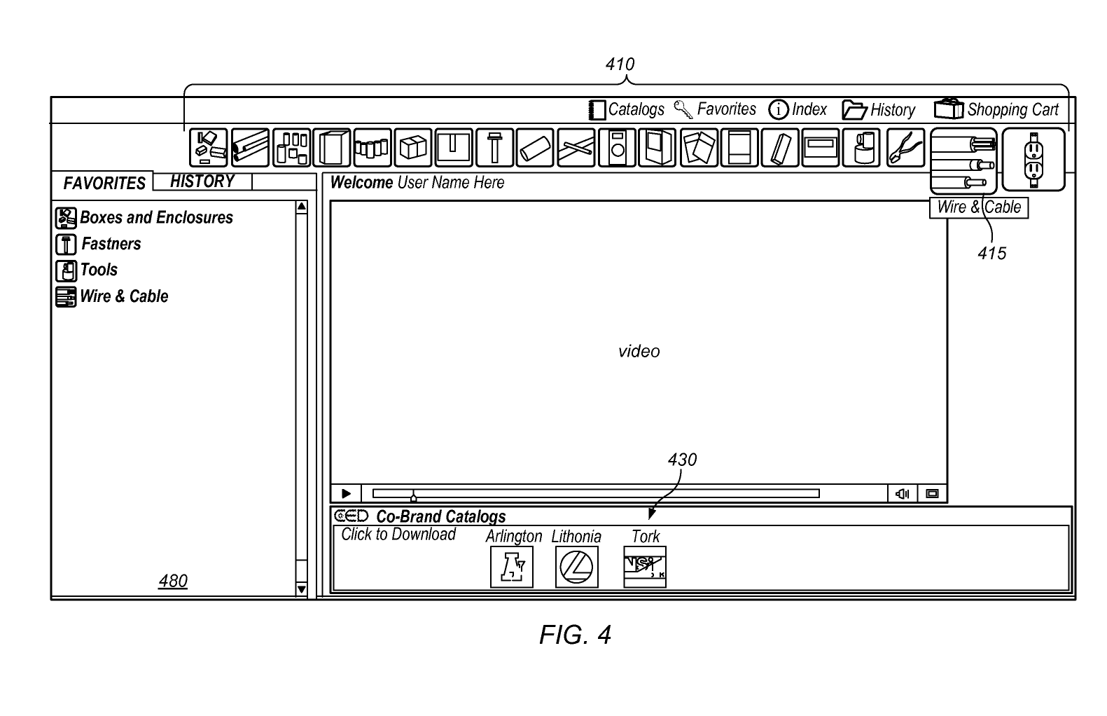

### FIGS. 4-18—Exemplary Screen Shots of the Method of FIG. 2

FIGS. 4-18 provide an exemplary walk through of the method of FIG. 2. Please note that while the screen shots shown in the screen may be more suitable for a typical computer program or browser, similar functionality may be implemented via portable devices, e.g., via a browser executing on the portable device and/or by dedicated applications executed by the portable device. Thus, the methods described herein may be executed by any of various computer systems or devices.

As shown in FIG. 4, a GUI of catalog(s) may be presented to the customer, which may assist the customer in selecting and ordering products. As shown, there may be a plurality of categories, shown visually as icons 410. In this particular instance, the customer has positioned his cursor over “wire and cable” icon 415. The GUI includes other options as well. For example, as shown, the customer may select from a plurality of favorite categories 480, which includes “boxes and enclosures”, “fasteners”, “tools”, and “wire and cable”. Additionally, the customer may select one or more cobrand catalogs, such as Arlington, Lithonia, or Tork (although other cobrand catalogs may be available in other embodiments). These cobrand catalogs may be specific to a particular manufacturer and distributor, e.g., the Arlington cobrand catalog may be particular to all products sold and manufactured by Arlington from a particular manufacturer. Additionally, the cobrand catalog may be branded with the distributor's logo (e.g., in addition to the manufacturer's logo). As also shown, within the GUI, the customer may be able to view videos or other information associated with products (e.g., files, such as data sheets, in pdf formats). In this particular example, the displayed video section may provide a video showing proper installation or use of a product.

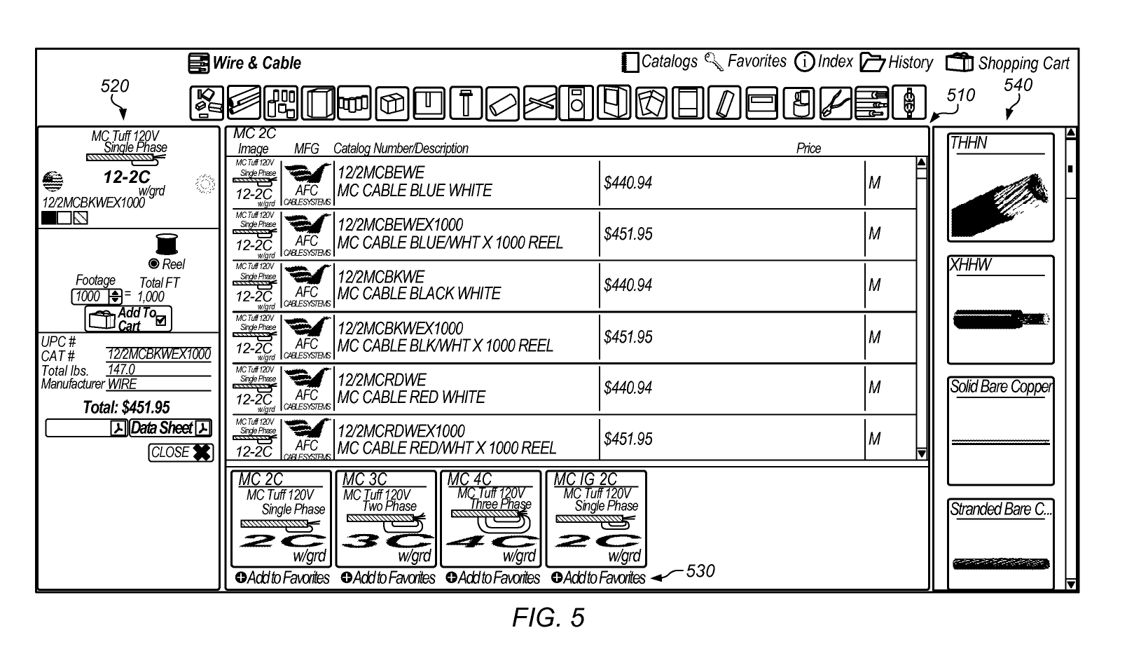

FIG. 5 illustrates a GUI after selection of the category “wire and cable”. In this GUI, a plurality of products within the category are shown in 510, which may be selectable by the customer. In this example, the customer has selected the cable “MC cable blck/wht×1000 reel”, which is also shown in the portion 520. In 520, the customer may select the total desired footage of the cable, view meta-data associated with the product (UPC #, Cat #, weight, manufacturer, etc.), view further information (e.g., a data sheet, installation videos, other information), and/or add the product to his cart. Where a different product is selected, other types of data may be specified (e.g., number of items rather than feet, etc.). In 530, the customer may add various products to his list of favorites for future selection or purchase. Additional product categories can be selected in 540.

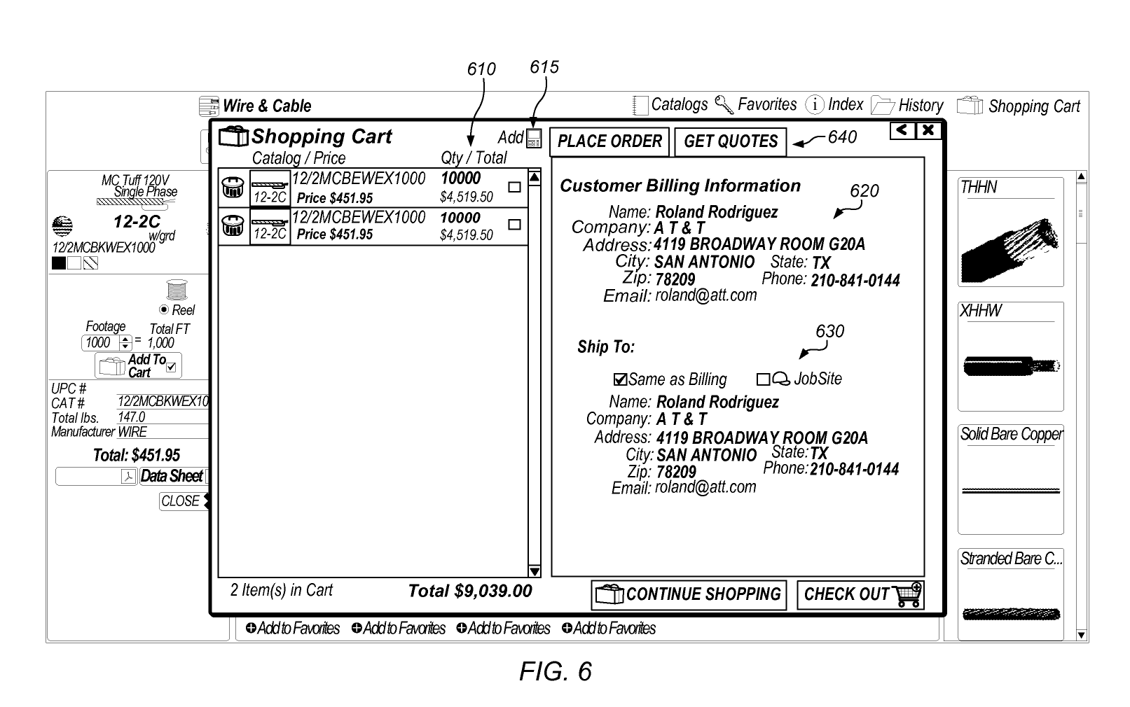

FIG. 6 illustrates a shopping cart GUI where the customer may perform various actions. In 610, the customer may view the current products in his shopping cart. As shown, the customer has selected two 10,000 foot reels of “12/2MCBEWEX1000”. As shown, the customer may select a trash can to delete the item, select each product to view more product information, edit the quantity of each item, and select whether to add items to a list of favorites (e.g., mobile favorites, as indicated by the cell phone icon) in 615. Additionally, a total price of the items are listed at the bottom of 610. The customer billing information is shown in 620 and the shipping information is shown in 630. Either or both of these may be customer modifiable in this GUI or in another location (e.g., by editing the profile of the customer). In 640, the customer may simply place the order (as is shown in this screenshot) or alternatively, may “get quotes” for the listed items. Additionally, the customer may “continue shopping” or “check out” (e.g., in the case of simply placing an order without requesting quotes).

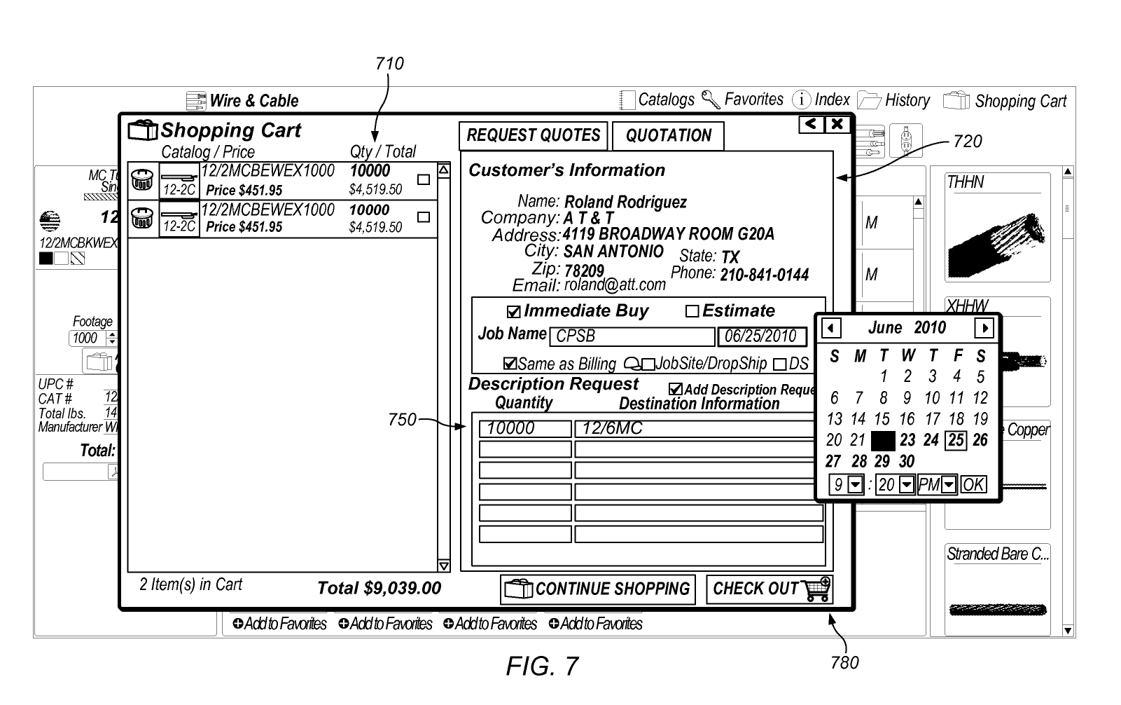

FIG. 7 illustrates the shopping cart GUI of FIG. 6, except where the customer is requesting a quote for the listed items. In this GUI, the portion 710 remains the same as in FIG. 6. However, the right-hand portion of the GUI has changed. As shown in 720, customer information may be shown and various further information may be received to specify the quote. In this example, the customer has selected an “immediate buy” (instead of “estimate”) where the customer is indicating that the items need to be purchased (rather than are being used to provide a quote on a service or job). The customer may also specify a job name and a need by date. In this particular example, the customer may specify the need by date using a calendar, and may also specify the time that it is required on that particular day. Finally, the customer is also able to add a description of a desired product. In this example, the customer has requested 10,000 feet of 12/6MC wire without identifying a particular part in a catalog as he did for the 12/2MC wire shown in 710. The customer may select the button “send quote” 780 to begin the quotation process.

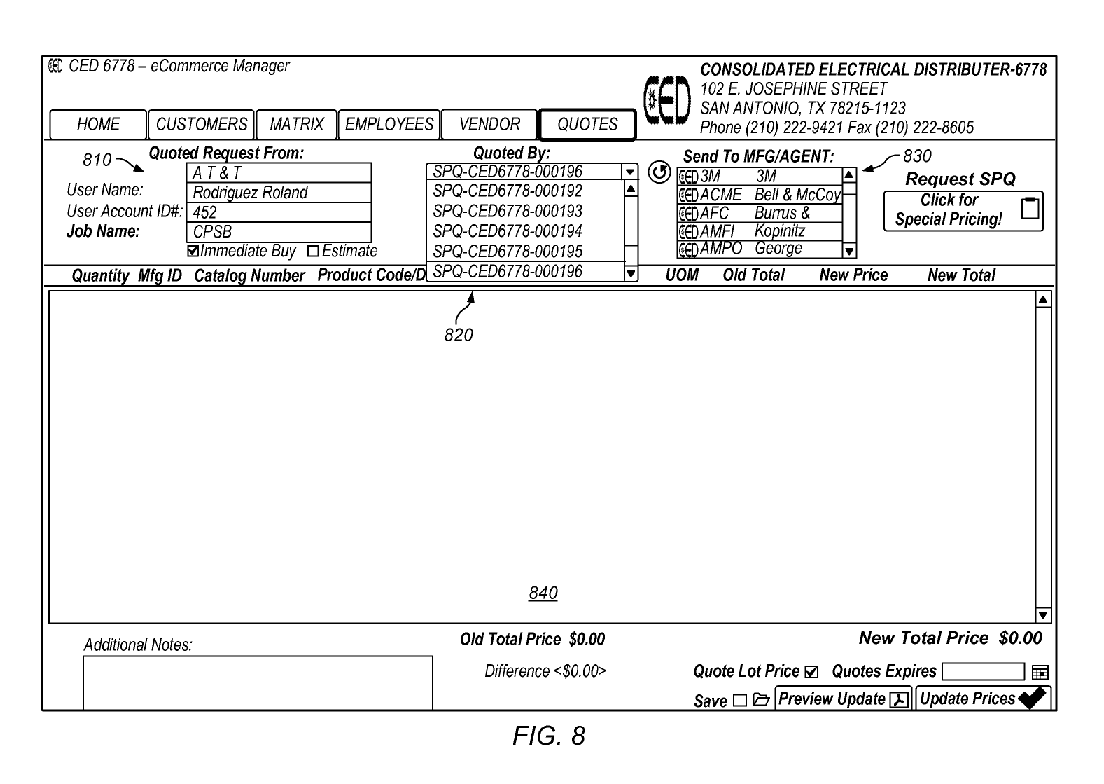

FIG. 8 illustrates a GUI for a distributor, who may receive the quote request specified in FIG. 4-7. In this case, section 810 shows the customer information, including corporate affiliation (AT&T), customer name (Rodriguez Roland), customer account ID number (452), job name (CPSB) and buy type (immediate buy). The distributor can select the newest quote (SPQ-CED6778-000196) from a list of a plurality of quotes 820. In 840, information of the quote may be displayed, but none is shown since a quote has not been selected yet. Additionally, the distributor may select whether or not to give the customer a lot price using the “quote lot price” checkbox and may also specify a quote expiration date. Finally, the distributor may be able to select a particular manufacturer or agent and request a special price quote from that manufacturer or agent.

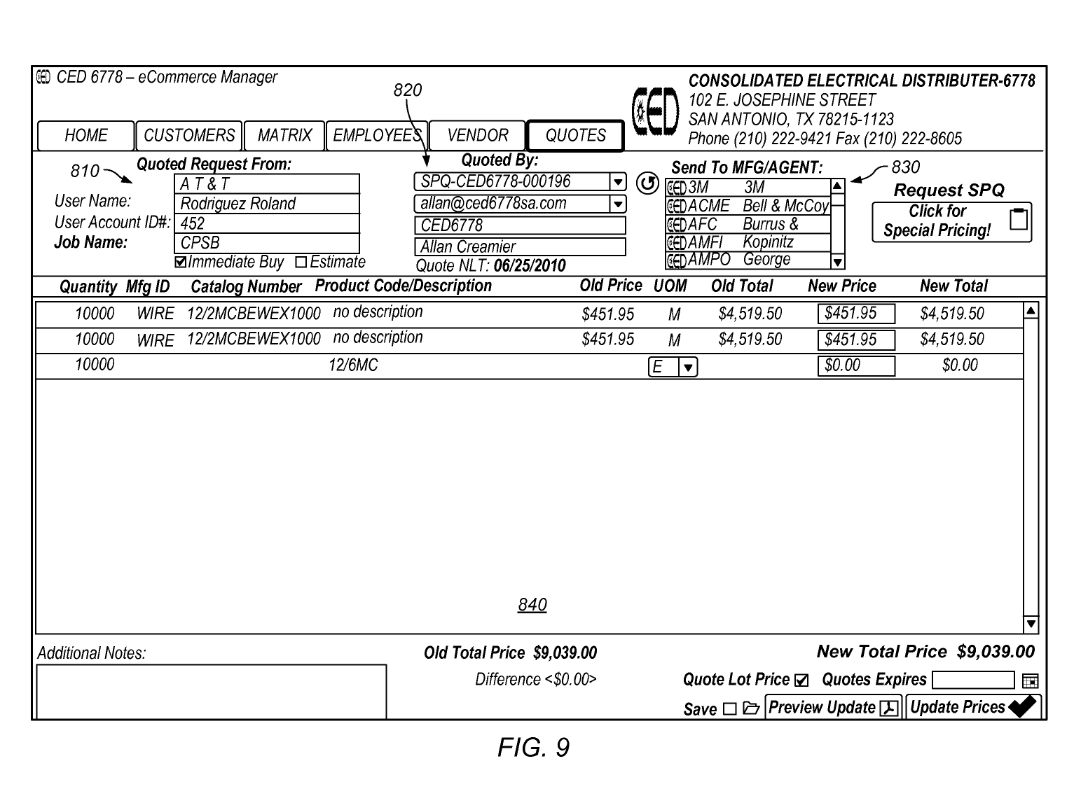

FIG. 9 illustrates an updated GUI of FIG. 8 where the quote request is received. As shown 810 and 830 may include the same information as 710 and 730. However, in 820, the distributor information is shown. In this case, the particular quote (SPQ-CED6778-000196) is shown) as well as the email address of the particular distributor (allan@ced6778sa.com), the CED quote (CED6778) and the distributor's name “Allan Creamier”. In 840, the information from the quote is now displayed. As shown, the distributor may update the pricing and add further information to the described product (e.g., manufacturer ID, catalog number, pricing information, etc.).

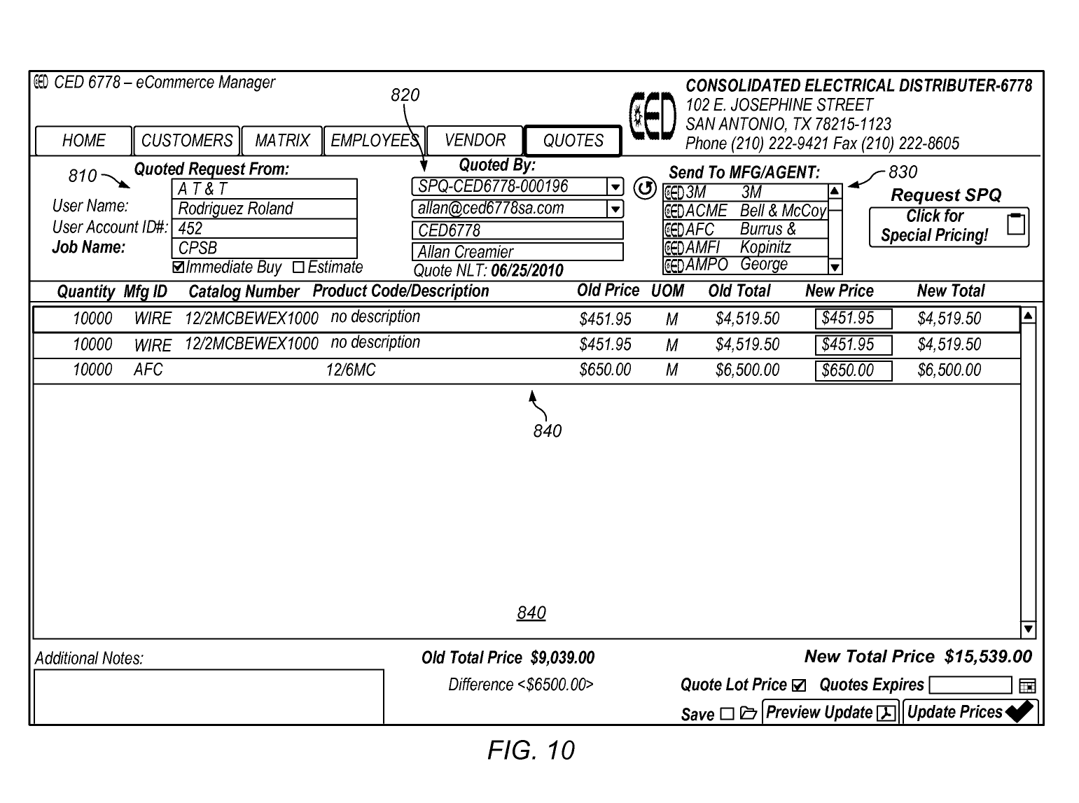

FIG. 10 illustrates an updated GUI where the distributor has updated the described product. As shown, the distributor has selected catalog part number (12/6MCBEBKWEX1000), the manufacturer (AFC), the old price (650), the UOM (M), the Old total (6500), the new price 650) and the new total (6500) for the described product. Note that various ones of these fields may be automatically specified based on user input, e.g., all of these fields may be automatically updated once the distributor selects the catalog number. As also shown, the new total price has been updated to 15,539.

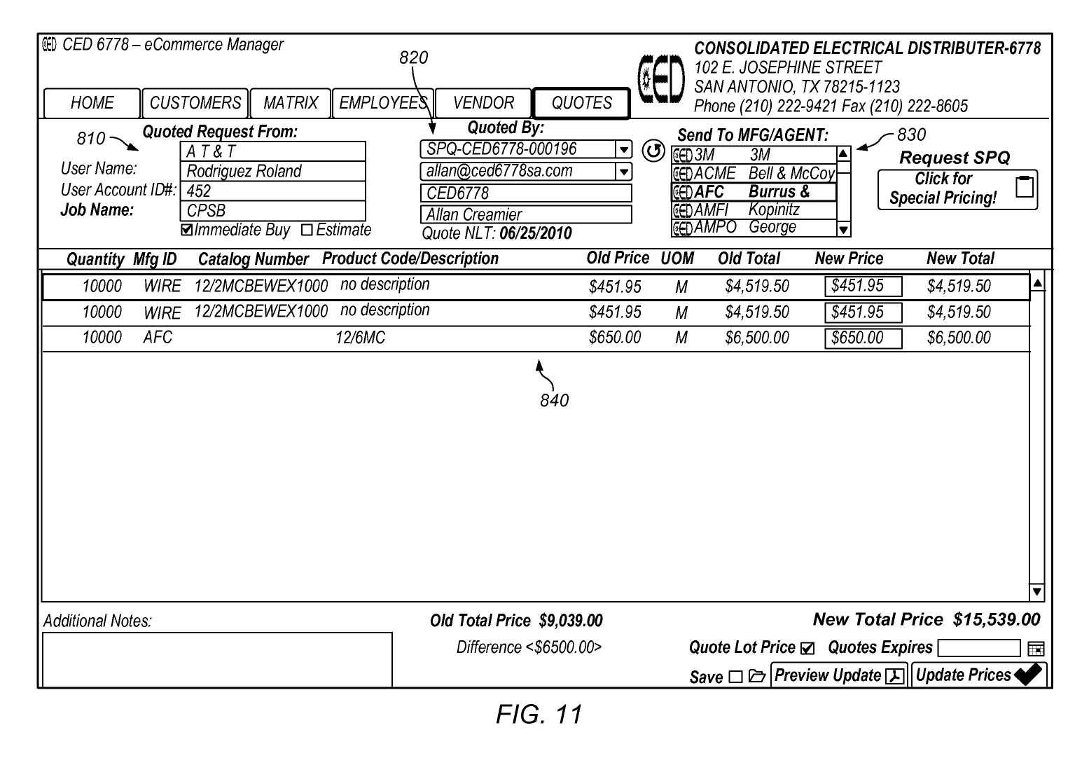

FIG. 11 illustrates an updated GUI where the distributor has selected the manufacturer AFC, with contact Burrus in 830.

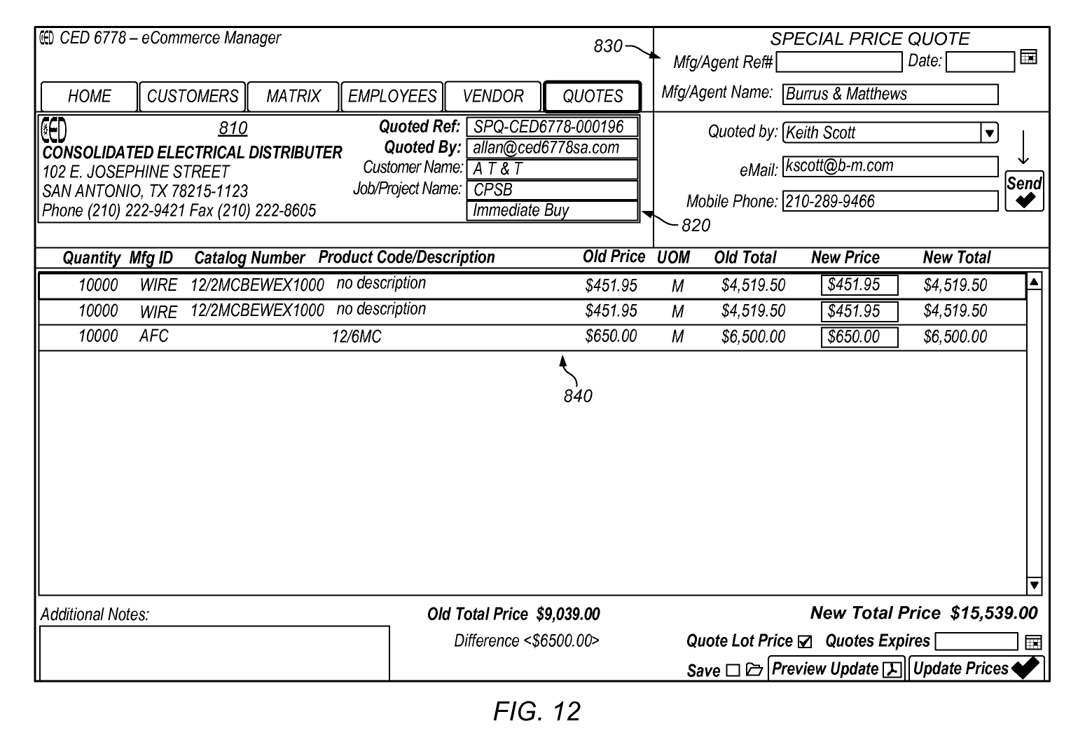

FIG. 12 illustrates an updated GUI where the special price quote information is specified for the contact Burrus & Matthews. As shown, the contact information may be “Keith Scott” with email “kscott@b-m.com” and phone number “210-289-9466”. The distributor may then select the “send” button to send this special quote request to the manufacturer, Keith Scott, who may represent AFC. However, in some embodiments, the distributor may be able to simply update the pricing with a better price for the customer (e.g., instead of sending it on to the manufacturer). Thus, in some embodiments, a quote may be generated at this point and provided to the customer.

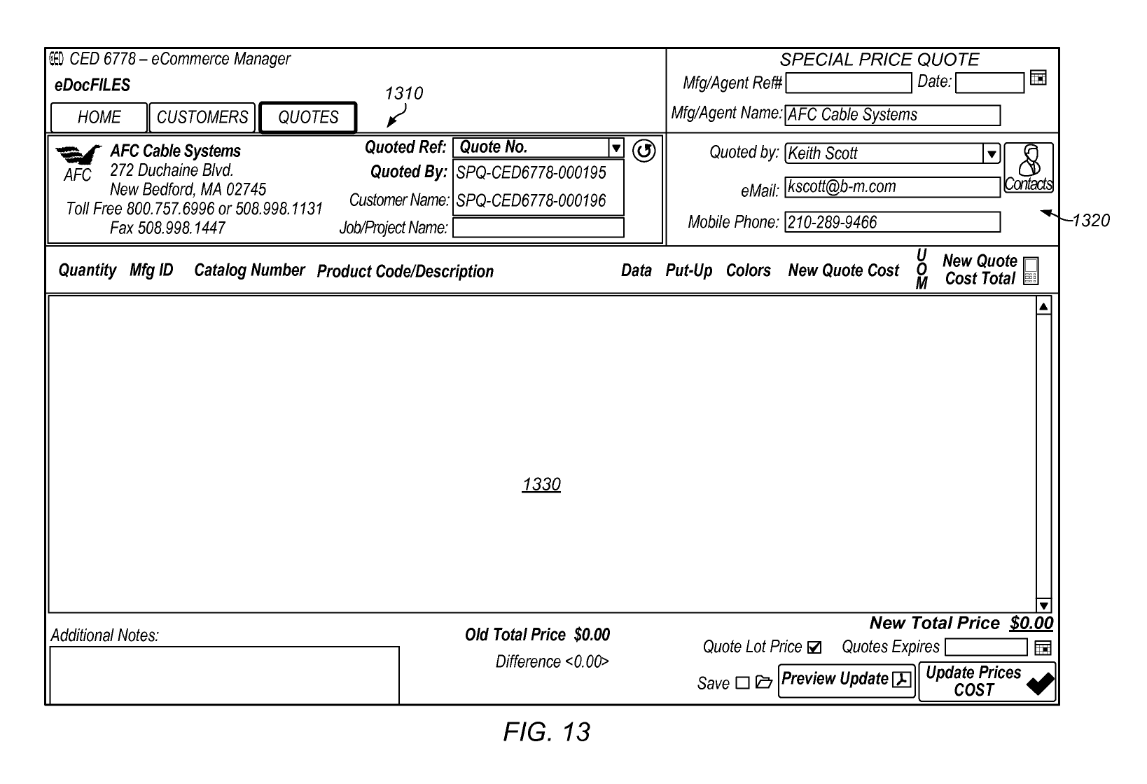

FIG. 13 illustrates a GUI for the manufacturer (where the distributor has sent it on to the manufacturer) Keith Scott (reflected in 1320, which shows the previously entered contact information of 830). As shown, 1310 has the information of the manufacturer (AFC) and the manufacturer may select the quote request from a plurality of quote requests. This information may be provided in 1330 upon selection.

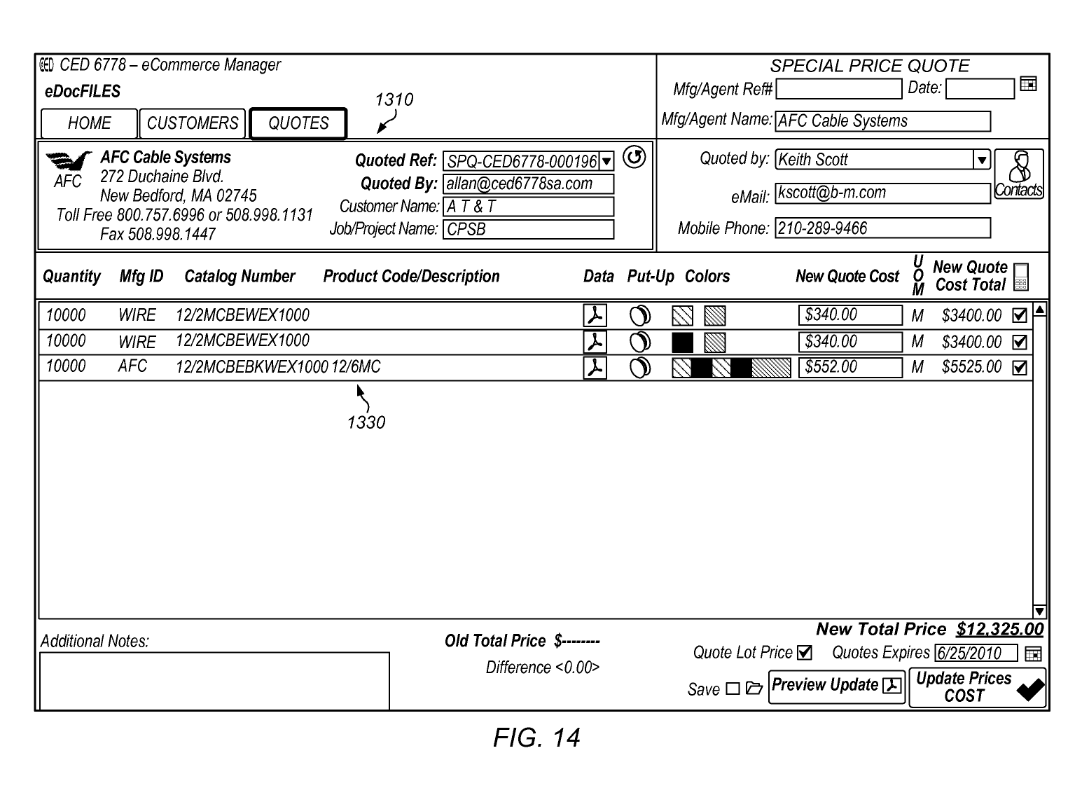

FIG. 14 illustrates an updated GUI after selection of the quote SPQ-CED6778-000196. As shown in 1310, the quote was provided from allan@ced6778sa.com, with customer name AT&T, and job name CPSB. In FIG. 14, the section 1330 has been updated with the information of the quote. In this example, the manufacturer has edited the prices for each item and given the customer a price break due to the volume of the purchase. Additionally, the new total price has been updated and the quote expiration has been specified (Jun. 25, 2010). In the particular embodiment shown, the manufacturer agent Keith Scott (part of Burrus and Matthews) has changed the price. However, in further embodiments, Keith Scott may provide this quote to a manufacturer representative first, and either Keith or the representative may change the price as shown. Thus, in further embodiments, the quote may be sent and received from an additional entity (e.g., the manufacturer representative) than that shown in this walk through. In this particular embodiment, the agent is shown since the agent may be more familiar (e.g., may have more contacts) with the local area of the distributor and/or the customer than a manufacturer representative might.

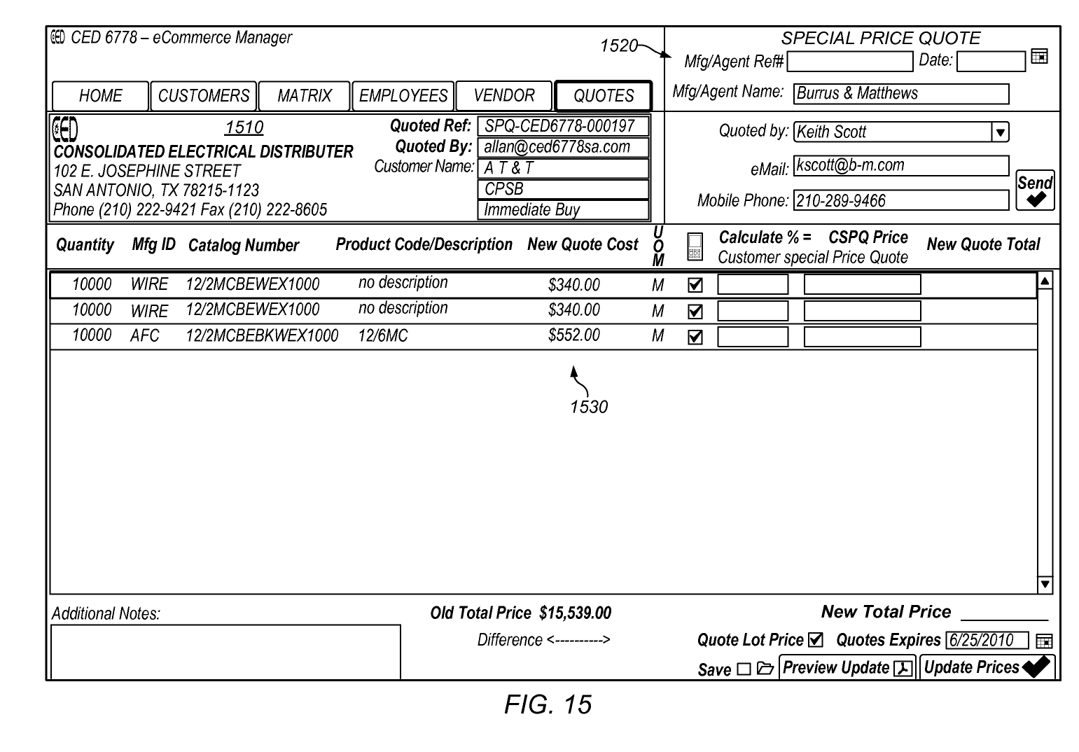

FIG. 15 is an updated GUI where the distributor may review the special pricing proposal from the manufacturer. In this GUI, the distributor information is shown in 1510 and the manufacturer contact information is shown in 1520. Additionally, in the quote information of 1530, the distributor may add a markup percentage and/or simply specify the price for each item, resulting in an automatic update of the new quote total. The distributor may also select whether or not to send this quote information to his (or the customer's) cell phone.

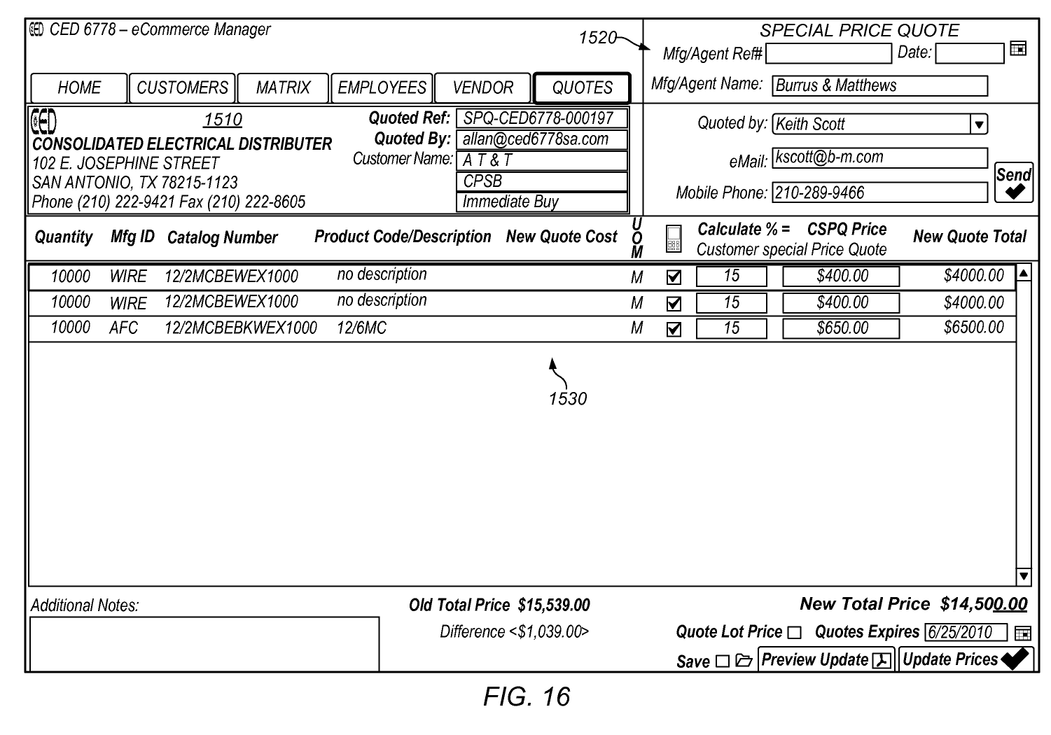

FIG. 16 illustrates an updated GUI where the distributor has added a 15% markup to the prices, resulting in a new total price of 14,500 with a difference of 1,039.

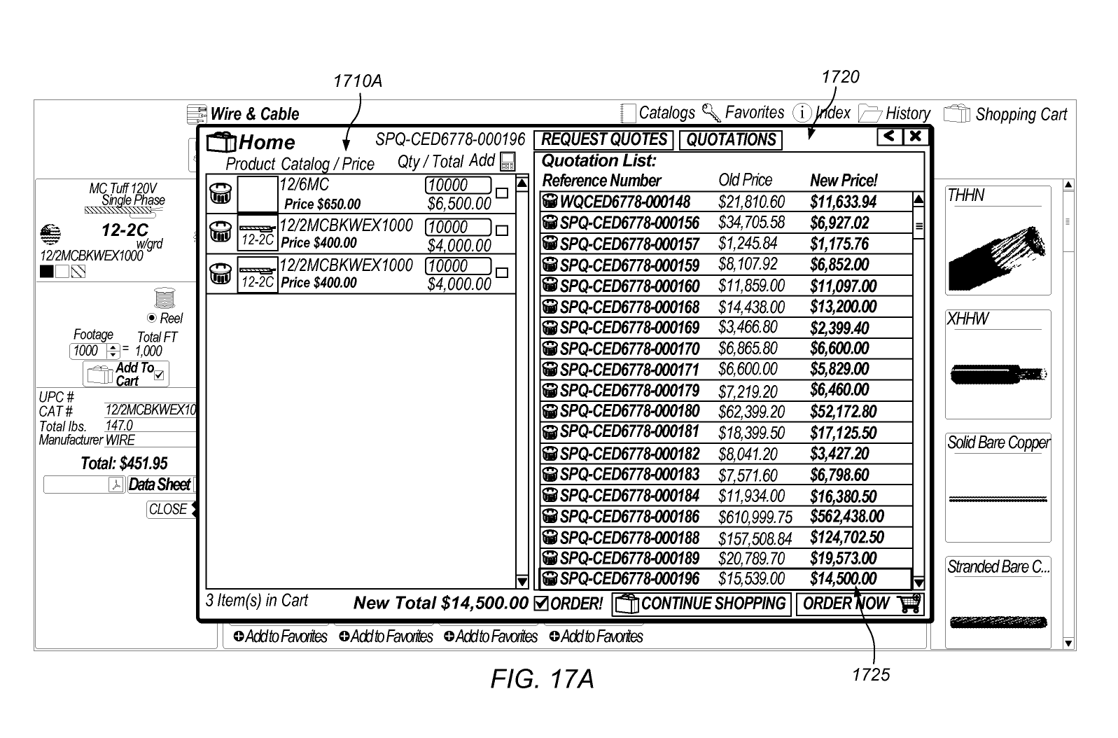

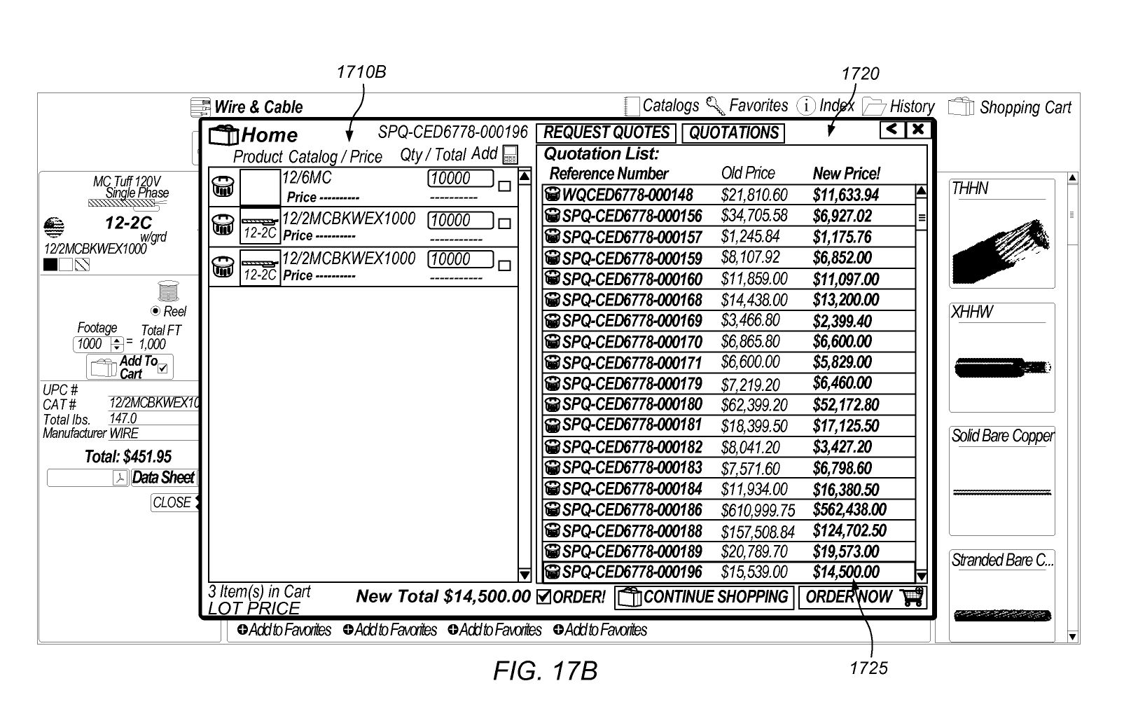

FIG. 17A illustrates the quote from the distributor from the customer's shopping cart. As shown, the customer may select the quote “SPQ-CED6778-000196” from his list of quotes in 1720. In this embodiment, the quote is shown as a unit quote, where the special prices are shown for each item. In FIG. 17B, these unit prices are not shown, and only a price for the entire quote (or “lot”) is shown. In this particular walk through, the pricing would be shown as in FIG. 17B since the distributor selected “lot pricing” in his GUI. The user may be able to export these displayed quotes into various formats (e.g., excel, pdf, etc.) in order to utilize them in other fashions, e.g., for importing into other systems (e.g., for order management, budgeting, etc.). In some embodiments, the customer may be able to export these via an icon (e.g., per quote) in 1720. Additionally, the customer may be able to modify the desired quantity after receiving the quote, e.g., based on updated information about the required job (or other jobs). However, this feature may be selectively added or removed, e.g., in response to distributor or manufacturer input (e.g., similar to the checkbox for lot pricing).

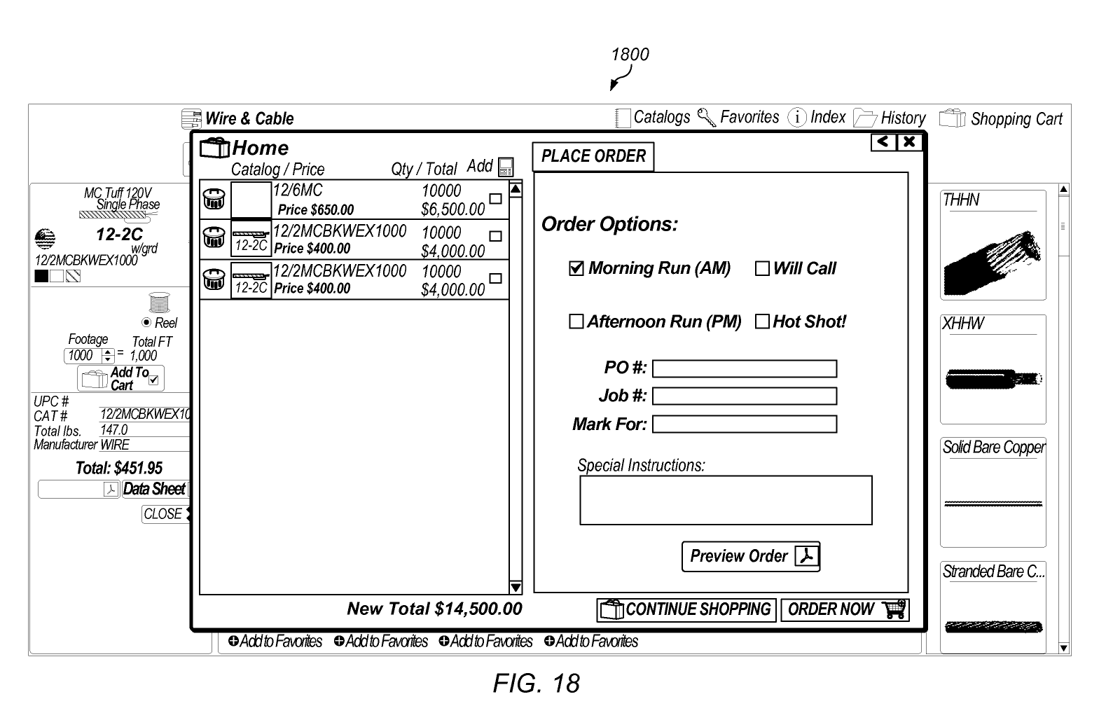

FIG. 18 illustrates the product purchase screen 1800 where the customer can place the order using the special pricing agreement. In this GUI, the customer may specify various order options, such as “Morning Run (AM)”, “Will Call”, “Afternoon Run (PM)”, “Hot Shot”, as well as other information, such as PO#, Job #, Mark for, special instructions, etc. The customer may also preview the order before placing it.

During the process above, throughout each completion, an email may be sent to the customer, the distributor (e.g., the particular user of the distributor involved in the process), and/or the manufacturer (e.g., the particular user of the manufacturer involved in the process). For example, the customer may receive an email of the quote request and/or the final order. Additionally, the distributor may receive an email of the quote request, before and/or after his input, and/or the quote, before and/or after the his input.

Thus, FIGS. 4-18 illustrate one embodiment of a method for establishing special pricing for one or more products.

Where the customer has established special pricing agreements, the customer may be able to view products at the special price and checkout with that special price without having to go through the quote process from FIG. 2. Additionally, in one embodiment, the customer may utilize a previous quote (e.g., with special pricing) and modify or simply use that quote for purchase (e.g., rather than using the quote process from above).

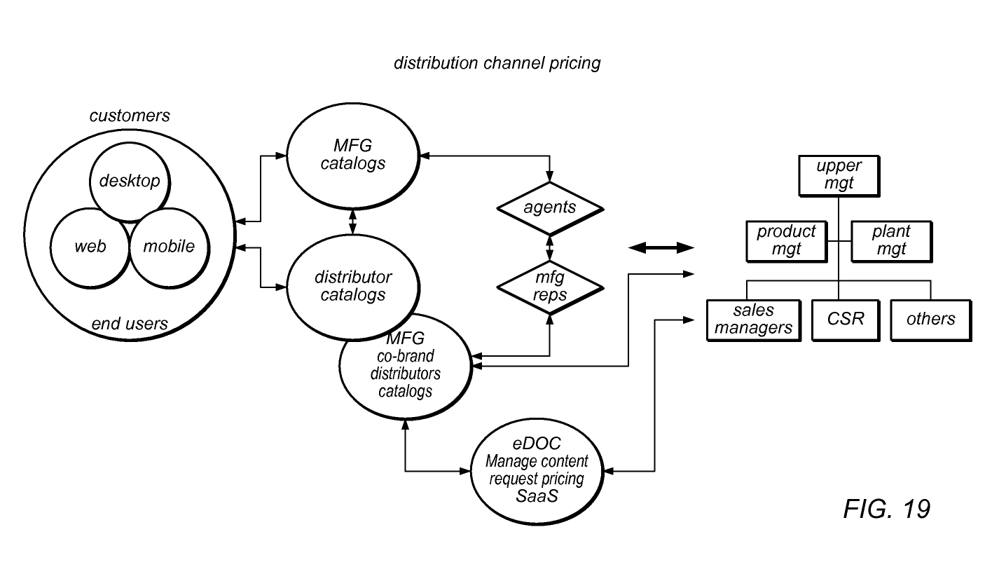

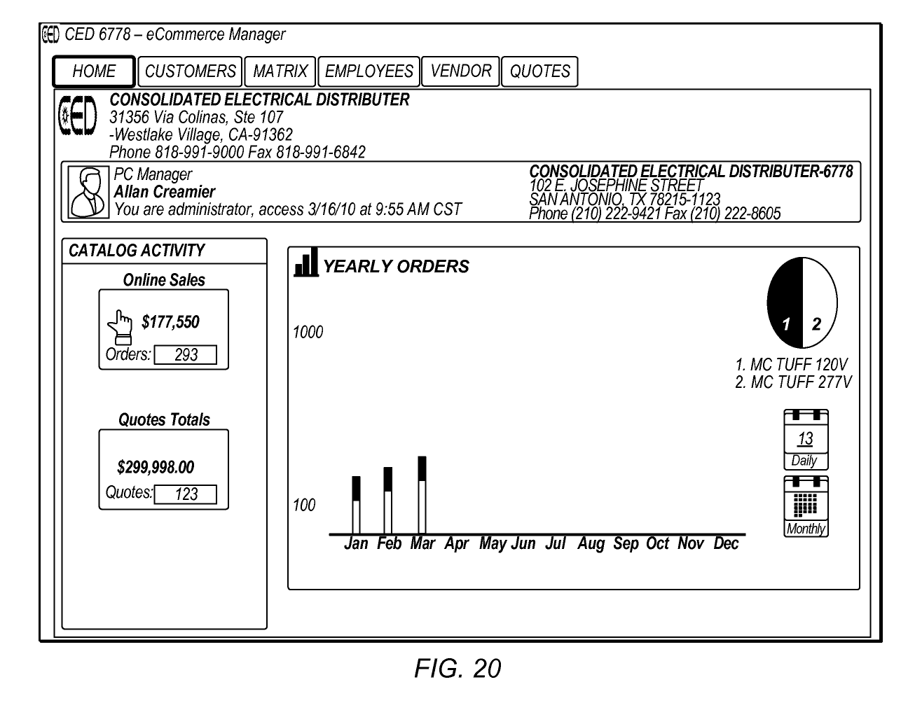

### FIGS. 19-20—Further Exemplary Diagrams

FIG. 19 illustrates an exemplary diagram showing the flow of information. As shown, customers may receive information corresponding to manufacturer catalogs and/or distributor catalogs. In some embodiments, the catalogs may be cobranded with a distributor and manufacturer. These catalogs may be provided via manufacturer agents and/or representatives or manufacturer sales managers, CSRs or other people associated with manufacturers. The purchase information may be provided to the distributors, agents and manufacturers via the eDOC and SaaS service (e.g., which may provide the methods described herein, e.g., via websites). As shown, this service may be tied to backend systems and EDI partners of the distributors and manufacturers. In some embodiments, the manufacturers may have to provide information in the management tree shown, where sales managers, CSRs and/or others may have to check with the product managers, plant managers, or upper management to determine whether a special pricing proposal (or the particular special pricing agreement) can be reached. For example, a manufacturer may be more willing to provide a discounted price if a plant has produced an excess of a product, but may be less willing if that product is not in stock or requires special production.

FIG. 20 illustrates an exemplary GUI where users may review performance information of a particular agent or representative (e.g., for the distributor or manufacturer). As shown, yearly orders may be shown as well as total numbers of orders, online sales information, quote totals, etc.

### Further Embodiments

In further embodiments, pricing may be established directly between the customer and the manufacturer, e.g., without involving the distributor or without including a mark up of the price by the distributor. In one embodiment, the special pricing agreement may be established and used similar to embodiments described above, except that a distributor's interaction may be removed completely or minimized. For example, the quote request may be provided directly to the manufacturer who may then respond to the customer (instead of the distributor).

Additionally, the distributor and/or manufacturer may receive information via backend systems run by the distributor and/or manufacturer (e.g., executed by the computer systems 120 or 130) or EDI partners. For example, the various quote requests, special pricing agreements, special pricing proposals, quotes, etc. may be provided to these backend systems or EDI partners throughout the process, as appropriate or desired.

In some embodiments, the provided service may provide a dashboard for sales and quotes, a profile for customers to manage passwords to catalogs and online sales and quotes, a pricing matrix for customers, a management area for adding, modifying, deleting employees (e.g., passwords, etc.), an ability to tie manufacturers to representatives, agents, or associates for pricing, etc.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer accessible memory medium storing program instructions for managing pricing between customers, distributors and manufacturers, wherein the program instructions are executable by a processor to:
store a plurality of product catalogs;
store information regarding special pricing agreements for a plurality of customers, wherein, for each respective customer, the special pricing agreement information comprises information on special pricing for certain products previously negotiated by the respective customer with a respective distributor and/or manufacturer;
receive first customer identification information from a first customer device identifying a first customer, wherein the first customer identification information is received over a wide area network;
identify the first customer based on the customer identification information;
provide first catalog information for display to the first customer, wherein the first catalog information is provided over the wide area network, wherein the first catalog information is generated based on at least one of the plurality of product catalogs and special pricing agreement information for the first customer, wherein the first catalog information comprises special pricing for the first customer, wherein the catalog information includes a special price for a first product; and
receive and store first customer input specifying purchase of a quantity of the first product, wherein the first customer input is received over the wide area network, wherein the first customer input specifying purchase of the quantity of the first product indicates a purchase of the quantity of the first product at the special pricing.

2. The memory medium of claim 1,
wherein said receiving first customer identification information from the first customer device identifying the first customer comprises receiving a digital certificate from the first customer device, wherein the digital certificate is specific to the first customer device.

3. The memory medium of claim 1,
wherein the first customer device comprises a portable device.

4. The memory medium of claim 1,
wherein the first catalog information is specific to a particular distributor and a particular manufacturer.

5. The memory medium of claim 4,
wherein the first catalog information comprises a restricted portion of the particular manufacturer's products based on the particular distributor.

6. The memory medium of claim 1, wherein the special pricing agreement for the first product has an associated expiration date, wherein the program instructions are further executable to:
determine whether the special pricing agreement for the first product is still valid based on the expiration date;
wherein said providing is performed based on said determining.

7. The memory medium of claim 1, wherein said providing the first catalog information comprises providing a list of one or more favorite products, wherein the list comprises the first product, wherein said receiving input comprises selecting the first product from the list.

8. The memory medium of claim 1, wherein said receiving the first customer input specifying the purchase of the first quantity of the first product comprises:
providing a previous order including the first product; and
receiving user input modifying the previous order.

9. A method for managing pricing between customers, distributors and manufacturers, the method comprising:
storing a plurality of product catalogs in computer memory;
storing information in the computer memory regarding special pricing agreements for a plurality of customers, wherein, for each respective customer, the special pricing agreement information comprises information on special pricing for certain products previously negotiated by the respective customer with a respective distributor and/or manufacturer;
receiving first customer identification information from a first customer device identifying a first customer, wherein the first customer identification information is received over a wide area network;
identifying the first customer based on the customer identification information;
providing first catalog information for display to the first customer, wherein the first catalog information is provided over the wide area network, wherein the first catalog information is generated based on at least one of the plurality of product catalogs stored in computer memory and special pricing agreement information for the first customer, wherein the first catalog information comprises special pricing for the first customer, wherein the catalog information includes a special price for a first product;
receiving and storing first customer input specifying purchase of a quantity of the first product, wherein the first customer input is received over the wide area network;
wherein the first customer input specifying purchase of the quantity of the first product indicates a purchase of the quantity of the first product at the special pricing.

10. The method of claim 9,
wherein said receiving first customer identification information from the first customer device identifying the first customer comprises receiving a digital certificate from the first customer device, wherein the digital certificate is specific to the first customer device.

11. The method of claim 9,
wherein the first catalog information is specific to a particular distributor and a particular manufacturer.

12. The method of claim 9, wherein the special pricing agreement for the first product has an associated expiration date, wherein the method further comprises:
determining whether the special pricing agreement for the first product is still valid based on the expiration date;
wherein said providing is performed based on said determining.

13. The method of claim 9, wherein said providing the first catalog information comprises providing a list of one or more favorite products, wherein the list comprises the first product, wherein said receiving input comprises selecting the first product from the list.

14. The method of claim 9, wherein said receiving the first customer input specifying the purchase of the first quantity of the first product comprises:
providing a previous order including the first product; and
receiving user input modifying the previous order.

15. A system, comprising:
a plurality of web servers, comprising processors and memories, wherein the memories store program instructions executable by the processors to:
store a plurality of product catalogs;
store information regarding special pricing agreements for a plurality of customers, wherein, for each respective customer, the special pricing agreement information comprises information on special pricing for certain products previously negotiated by the respective customer with a respective distributor and/or manufacturer;
receive first customer identification information from a first customer device identifying a first customer, wherein the first customer identification information is received over a wide area network;
identify the first customer based on the customer identification information;
provide first catalog information for display to the first customer, wherein the first catalog information is provided over the wide area network, wherein the first catalog information is generated based on at least one of the plurality of product catalogs stored in computer memory and special pricing agreement information for the first customer, wherein the first catalog information comprises special pricing for the first customer, wherein the catalog information includes a special price for a first product; and
receive and store first customer input specifying purchase of a quantity of the first product, wherein the first customer input is received over the wide area network, wherein the first customer input specifying purchase of the quantity of the first product indicates a purchase of the quantity of the first product at the special pricing.

16. A computer accessible memory medium storing program instructions for establishing pricing between a first customer and a manufacturer, wherein the program instructions are executable by a processor to:
receive first customer identification information from a first customer device identifying a first customer, wherein the first customer identification information is received over a wide area network;
provide first catalog information for display to the first customer, wherein the first catalog information is provided over the wide area network, wherein the first catalog information specifies a price for a first product;
receive customer input specifying a quote request, wherein the quote request specifies a product purchase over the wide area network, wherein the product purchase specifies the first product and a quantity of the first product;
provide the product purchase to the manufacturer over the wide area network;
receive special pricing proposal information from the manufacturer computer over the wide area network;
provide the special pricing proposal information to the distributor computer over the wide area network;
receive a quote for the product purchase from the distributor computer over the wide area network, wherein the quote for the product purchase from the distributor computer is based on the special pricing proposal information from the manufacturer computer, wherein the quote comprises a special pricing agreement for the product purchase for the first customer, wherein the special pricing agreement price for the first product is less than the price for the first product;
provide the quote to the first customer device over the wide area network;
store the special pricing agreement for the product purchase in response to said receiving the quote, wherein the special pricing agreement is associated with the first customer identification information and is useable to establish pricing for the first product for the first customer.

17. The memory medium of claim 16, wherein the program instructions are further executable to:
provide the quote request to a distributor computer over the wide area network;
receive contact information for a manufacturer from the distributor computer over the wide area network;
wherein said providing the product purchase to the manufacturer is based on the contact information.

18. The memory medium of claim 16,
wherein the customer input specifies a need by date and time for the product purchase.

19. The memory medium of claim 16,
wherein the customer input specifies a shipping destination for the product purchase.

20. The memory medium of claim 16,
wherein the customer input specifies the first product via a product description.

21. The memory medium of claim 20, wherein the program instructions are further executable to:
receive a manufacturer part number of the first product from the distributor computer over the wide area network, wherein said providing the product purchase to the manufacturer comprises providing the manufacturer part number of the first product.

22. The memory medium of claim 16, wherein the product purchase specifies a first quantity of a second product, wherein the quote comprises either lot or unit pricing based on the distributor computer or the manufacturer.

23. A method for establishing pricing between a first customer and a manufacturer, the method comprising:
receiving first customer identification information from a first customer device identifying a first customer, wherein the first customer identification information is received over a wide area network;
providing first catalog information for display to the first customer, wherein the first catalog information is provided over the wide area network, wherein the first catalog information specifies a price for a first product;
receiving customer input specifying a quote request, wherein the quote request specifies a product purchase over the wide area network, wherein the product purchase specifies the first product and a quantity of the first product;
providing the quote request to a distributor computer over the wide area network;
receiving contact information for a manufacturer from the distributor computer over the wide area network;
providing the product purchase to the manufacturer using the contact information over the wide area network;
receiving special pricing proposal information from the manufacturer computer over the wide area network;
providing the special pricing proposal information to the distributor computer over the wide area network;
receiving a quote for the product purchase from the distributor computer over the wide area network, wherein the quote for the product purchase from the distributor computer is based on the special pricing proposal information from the manufacturer computer, wherein the quote comprises a special pricing agreement for the product purchase for the first customer, wherein the special pricing agreement price for the first product is less than the price for the first product;
providing the quote to the first customer device over the wide area network;
storing the special pricing agreement for the product purchase in memory in response to said receiving the quote, wherein the special pricing agreement is useable to establish pricing for the first product for the first customer.

24. The method of claim 23,
wherein the customer input specifies a need by date and time for the product purchase.

25. The method of claim 23,
wherein the customer input specifies a shipping destination for the product purchase.

26. The method of claim 23,
wherein the customer input specifies the first product via a product description.

27. The method of claim 26, further comprising:
receiving a manufacturer part number of the first product from the distributor computer over the wide area network, wherein said providing the product purchase to the manufacturer comprises providing the manufacturer part number of the first product.

28. The method of claim 23, wherein the product purchase specifies a first quantity of a second product, wherein the quote comprises either lot or unit pricing based on input from the distributor computer or the manufacturer computer.

29. A system, comprising:
a plurality of web servers, comprising processors and memories, wherein the memories store program instructions executable by the processors to:
receive first customer identification information from a first customer device identifying a first customer, wherein the first customer identification information is received over a wide area network;
provide first catalog information for display to the first customer, wherein the first catalog information is provided over the wide area network, wherein the first catalog information specifies a price for a first product;
receive customer input specifying a quote request, wherein the quote request specifies a product purchase over the wide area network, wherein the product purchase specifies the first product and a quantity of the first product;
provide the quote request to a distributor computer over the wide area network;
receive contact information for a manufacturer from the distributor computer over the wide area network;
provide the product purchase to the manufacturer using the contact information over the wide area network;
receive special pricing proposal information from the manufacturer computer over the wide area network;
provide the special pricing proposal information to the distributor computer over the wide area network;
receive a quote for the product purchase from the distributor computer over the wide area network, wherein the quote for the product purchase from the distributor computer is based on the special pricing proposal information from the manufacturer computer, wherein the quote comprises a special pricing agreement for the product purchase for the first customer, wherein the special pricing agreement price for the first product is less than the price for the first product;
provide the quote to the first customer device over the wide area network;
store the special pricing agreement for the product purchase in memory in response to said receiving the quote, wherein the special pricing agreement is associated with the first customer identification information and is useable to establish pricing for the first product for the first customer.
